(19) United States
(12) Patent Application Publication
(10) Pub. No.: US 2009/0229763 A1
(43) Pub. Date: Sep. 17, 2009

(54) CORRECTION DEVICE HAVING RECEIVING AND REPLACEMENT FUNCTIONS

(76) Inventor: Nien-Chun Lin, Sinjhuang City (TW)

Correspondence Address: PAI PATENT & TRADEMARK LAW FIRM, 1001 FOURTH AVENUE, SUITE 3200, SEATTLE, WA, 98154, US

(21) Appl. No.: 12/045,705

(22) Filed: Mar. 11, 2008

(51) Int. Cl. B32B 37/12

(52) U.S. Cl. 156/577

(57) ABSTRACT

A correction device having receiving and replacement functions comprises a casing having a protruding opening at a front end thereof; and a rear end thereof having an insertion opening; an inner core having an inner casing, two rollers, a correction tape and a coating material at a front end thereof; the inner core inserting into the insertion opening and then passing through the coating material and then protruding out from the protruding opening; a resilient mechanism having a retaining unit installed in the casing; the retaining unit being combined to the first elastic unit so that the first elastic unit can eject the inner core in a direction opposite to an insertion direction of the inner core of the correction device; and a positioning unit having a press unit pivoted in the casing; a surface of the press unit adjacent to the inner core of the correction device being installed with a first stop block and a second stop block; an opposite surface thereof being installed with a second elastic unit so that an elastic force of the second stop block will eject the press unit, so that the first stop block and the second stop block are engaged to the inner core of the correction device.

### BACKGROUND OF THE INVENTION

(a) Field of the Invention

The present invention relates to correction devices, and particularly to a correction stationery device having receiving and replacement functions which is used to coat upon a writing or printing object for correction.

(b) Description of the Prior Art

The prior art correction device is used for correcting the errors in writing or printing. The correction device has a hollow casing. An interior of the correction device has an inner core. The inner core has another simple structured inner casing. Two rollers are installed within the inner casing. One roller is wound with a correction tape. A surface of the correction tape is coated with adhesive. When the correction tape passes through a coating material at a front end thereof and then passes through another roller so as to form as a prior art correction device. To be economic for reuse, replaceable inner cores are provided to replace an exhausted one.

However in the prior art, the casing is formed by an upper cover and a lower cover matched to the upper cover. The upper cover and lower cover are engaged by hooked sheets and recesses matched to the hooked sheets. However this structure cause that when replacing the inner core, the casing is difficult to be detached, even the hooked sheets and the recesses destroy so that the casing can not be used. Furthermore, the coating device at a front end of the inner core often protrudes out of the front end of the casing, and thus it is easy to be destroyed due to collision. Because it protrudes out of the casing, the correction material on the correction tape is easy to deteriorate.

### SUMMARY OF THE INVENTION

Accordingly, the object of the present invention is to provide an correction device having receiving and replacement functions, which is a special designed mechanism so that the inner core of the correction device is slidable within the casing so that it can be received into the casing and the inner core is replaceable.

To achieve above object, the present invention provides a correction device having receiving and replacement functions comprising a casing 1 having a protruding opening 13 at a front end thereof; and a rear end thereof having an insertion opening 14; an inner core 2 having an inner casing 21, two rollers, a correction tape 22 and a coating material 23 at a front end thereof; the inner core 2 inserting into the insertion opening 14 and then passing through the coating material 23 and then protruding out from the protruding opening 13; a resilient mechanism 3 having a retaining unit 31 installed in the casing 1; the retaining unit 31 being combined to the first elastic unit 34 so that the first elastic unit 34 can eject the inner core 2 in a direction opposite to an insertion direction of the inner core 2 of the correction device; and a positioning unit 4 having a press unit 41 pivoted in the casing 1; a surface of the press unit 41 adjacent to the inner core 2 of the correction device being installed with a first stop block 412 and a second stop block 413; an opposite surface thereof being installed with a second elastic unit 42 so that an elastic force of the second stop block 413 will eject the press unit 41, so that the first stop block 412 and the second stop block 413 are engaged to the inner core 2 of the correction device.

### BRIEF DESCRIPTION OF THE DRAWINGS

FIG. 1 is an explosive schematic view of the structure of the present invention.

FIG. 2 is an exploded perspective view about a part of the structure of the present invention.

FIG. 3 is an exploded perspective view of the inner core of the present invention.

FIG. 4 is a schematic view showing the assembly of the correction device of the present invention.

FIG. 5 is a cross sectional view showing the assembly of the correction device of the present invention.

FIG. 6 is a schematic view showing the operation of the correction device of the present invention.

FIG. 7 is a schematic view showing another operation of the correction device of the present invention.

### DETAILED DESCRIPTION OF THE PREFERRED EMBODIMENTS

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

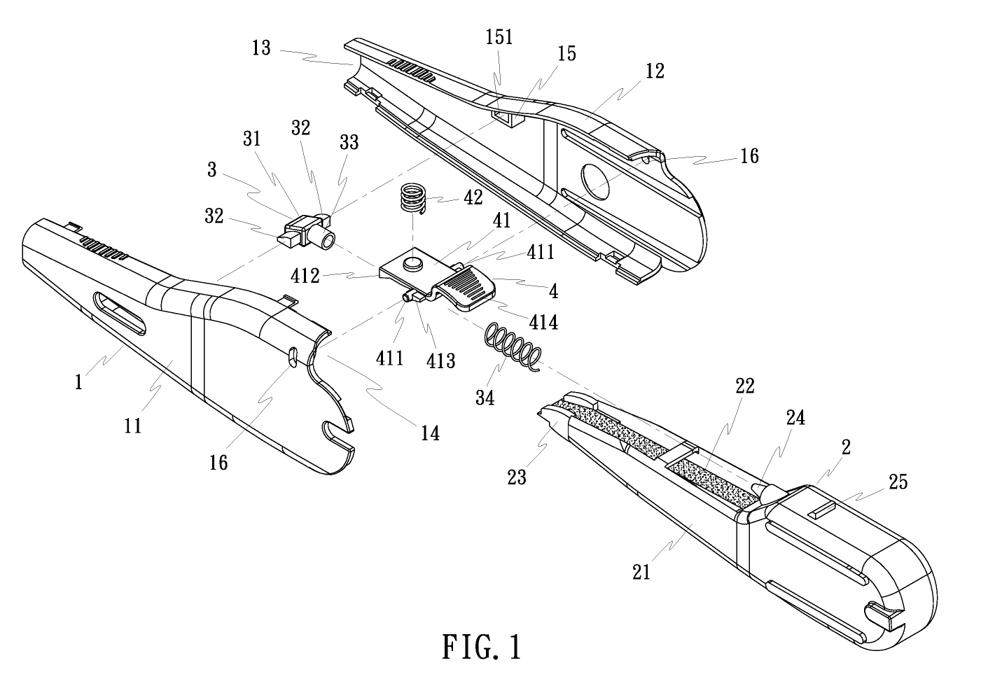

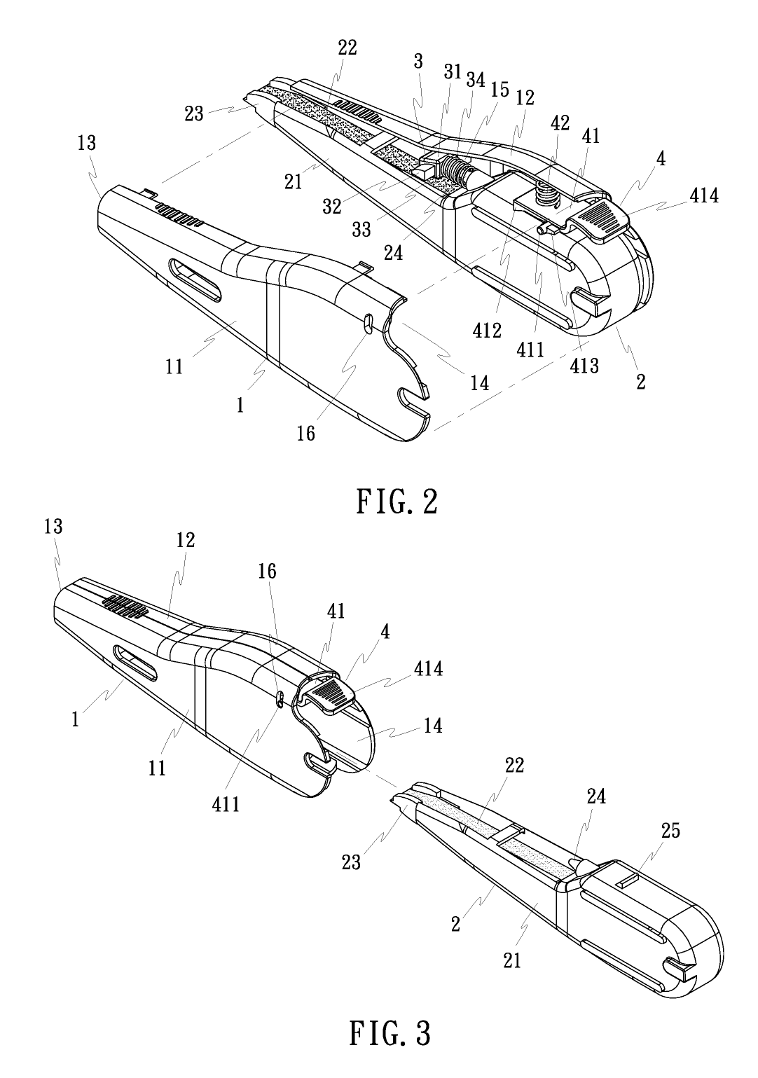

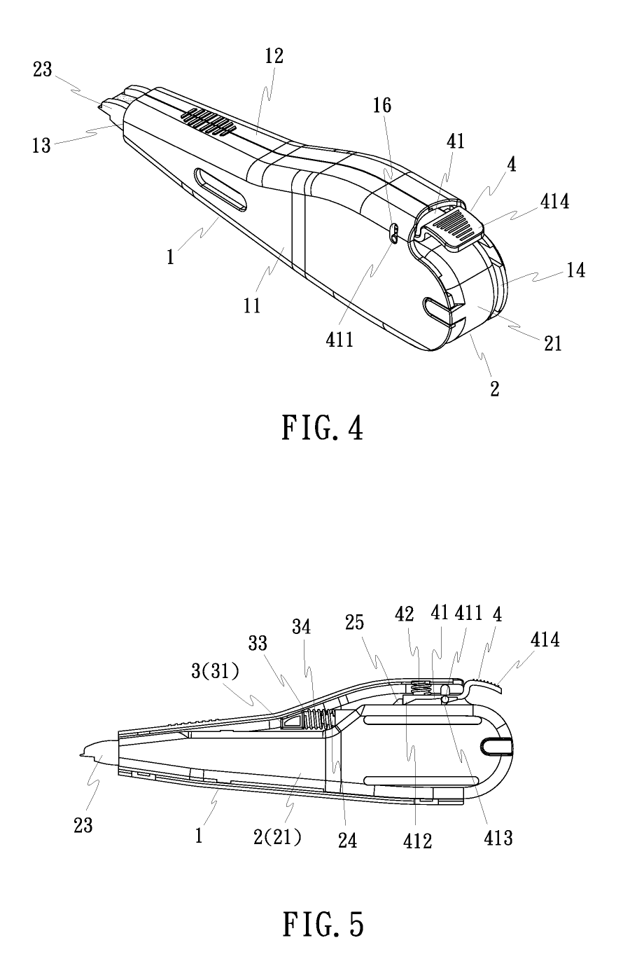

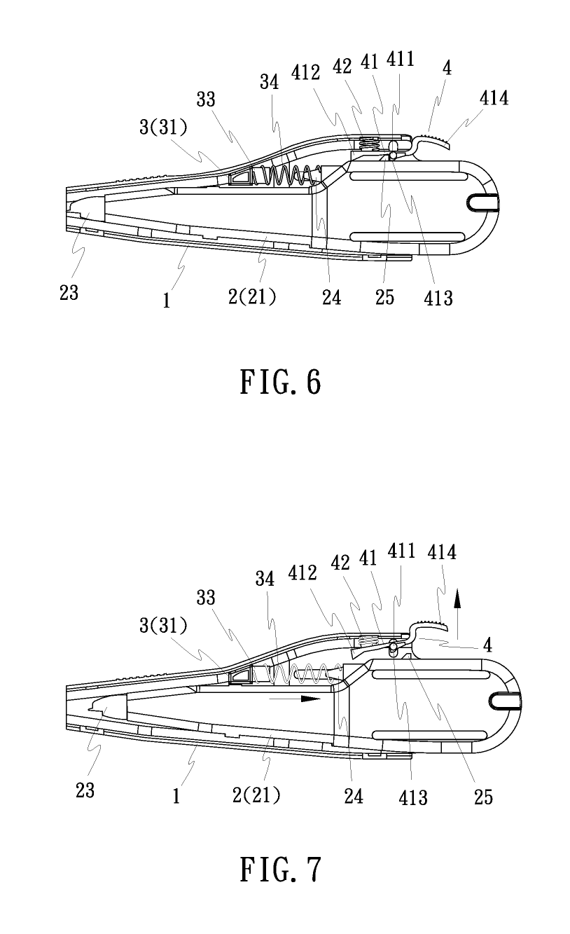

Referring to Figures, the correction device with receiving and replacing functions according to the present invention is illustrated. The structure includes a correction device, an inner core 2, a resilient mechanism 3, and a positioning unit 4. As shown in FIGS. 1 and 2, the casing 1 is formed by a first casing 1 and a second casing 2 matching to the first casing 1. The combination of the first casing 1 and second casing 2 is formed as a hollow shape therein. A front end of the casing 1 is formed with a protruding opening 13 and a rear end thereof is formed with a larger insertion opening 14. A retaining portion 15 and a pivotal hole 16 are formed within the casing 1. The retaining portion 15 has a recess 151 for retaining the resilient mechanism 3 described herebelow. An inner core 2, as shown in FIGS. 1 and 2, is a replaced inner core 2. The inner core 2 has a hollow inner casing 21. Two rollers are installed in the inner casing 21. A correction tape 22 winds around one roller so that a free end of the correction tape 22 passes through a coating material 23 at a front end thereof. Then the correction tape 22 winds through another roller within the inner casing 21. An axial shaft 24 is formed in a predetermined position of the inner casing 21. One lateral wall thereof has a protrusion 25. Thereby the inner core 2 can insert into the insertion opening 14 and then is slideable in the casing 1 (referring to FIGS. 3 and 4) so that the coating material 23 at the front end and a section of the correction tape 22 protrudes out from the protruding opening 13.

A resilient mechanism 3, as shown in FIGS. 1 and 2, has a retaining unit 31 combined to the casing 1. Each of two sides of the retaining unit 31 has a respective pivotal block 32 which is inserted into the recess 151 of the retaining portion 15. The retaining unit 31 is formed with an axial shaft 33 which is aligned to the axial shaft 24 of the inner core 2. The axial shaft 33 is combined with a first elastic unit 34, assembling the first elastic unit 34 so that it can provide an ejection elastic force with a direction reverse to the insertion direction of the inner core 2. The first elastic unit 34 may be a helical spring (referring to FIGS. 2 and 5) so that one end of the helical spring is engaged to the axial shaft 33 of the retaining unit 31. Another end thereof will push the axial shaft 24 of the inner core 2.

A positioning unit 4, as shown in FIGS. 1 and 2, has a press unit 41. Each of two sides of the press unit 41 is installed with a pivot shaft 411 which is pivoted to the pivotal hole 16 in the casing 1. A surface of the press unit 41 adjacent to the inner core 2 has a first stop block 412 and a second stop block 413. An opposite surfaces thereof is installed with a second elastic unit 42 which is helical spring so that the second elastic unit 42 resists against between an inner wall of the casing 1 and the press unit 41 so that the first stop block 412 and the second stop block 413 will buckle the protrusion 25 at the lateral side of the inner core 2 (referring to FIG. 5). Further, one end of the press unit 41 has a press sheet 414 extending out of the insertion opening 14 of the casing 1 for controlling the first stop block 412 and second stop block 413 to separate from the protrusion 25.

By above-mentioned structural features of the casing 1, inner core 2, resilient mechanism 3 and positioning unit 4, the structure of the present invention is formed, as shown in FIGS. 4 and 5. The inner core 2 is inserted into the casing 1 so that the protrusion 25 and the positioning unit 4 are buckled to the first stop block 412. The coating material 23 at the front end and a section of the correction tape 22 can protrude out of the protruding opening 13 for correction. After use, it is only necessary to press the press sheet 141 of the press unit 41, the first stop block 412 will separate from the protrusion 25, and then by the first elastic unit 34 of the resilient mechanism 3 will make the inner core 2 reduce inwards. If it is necessary to replace an inner core 2, it is only necessary to drive the press unit 41 to cause the second stop block 413 to separate from the protrusion 25 (referring to FIG. 7) so that the old inner core 2 can be retracted out.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A correction device having receiving and replacement functions comprising:
a casing having a protruding opening at a front end thereof;
and a rear end thereof having an insertion opening;
an inner core having an inner casing, two rollers, a correction tape and a coating material at a front end thereof; the inner core inserting into the insertion opening and then passing through the coating material and then protruding out from the protruding opening;
a resilient mechanism having a retaining unit installed in the casing; the retaining unit being combined to the first elastic unit so that the first elastic unit can eject the inner core in a direction opposite to an insertion direction of the inner core of the correction device; and
a positioning unit having a press unit pivoted in the casing; a surface of the press unit adjacent to the inner core of the correction device being installed with a first stop block and a second stop block; an opposite surface thereof being installed with a second elastic unit so that an elastic force of the second stop block will eject the press unit, so that the first stop block and the second stop block are engaged to the inner core of the correction device.

2. The correction device having receiving and replacement functions as claimed in claim 1, wherein the casing is formed with a first casing and a second casing which are formed with a hollow space and a retaining portion is installed in the casing; the retaining portion and the retaining unit combined; and the casing has a pivotal hole which is combined to the press unit of the positioning unit.

3. The correction device having receiving and replacement functions as claimed in claim 1, wherein an axial shaft is installed at a predetermined position of the inner core of the correction device; and the retaining unit of the resilient mechanism has an axial shaft which is combined with the first elastic unit so that the first elastic unit will eject the axial shaft of the inner core.

4. The correction device having receiving and replacement functions as claimed in claim 1, wherein a protrusion is formed at a predetermined position of the inner core; the protrusion is buckled to the first stop block or the second stop block of the press unit of the positioning unit.

5. The correction device having receiving and replacement functions as claimed in claim 1, wherein each of two lateral sides of the press unit has a pivot shaft which is pivoted in the casing; a surface of the press unit adjacent to the inner core is installed with a first stop block and a second stop block; and the second elastic unit at the opposite surface thereof will eject between an inner wall of the casing and the press unit.

6. The correction device having receiving and replacement functions as claimed in claim 1, wherein one end of the press unit is installed with a press sheet which extends out of the casing.

7. The correction device having receiving and replacement functions as claimed in claim 1, wherein the first elastic unit is a helical spring.

8. The correction device having receiving and replacement functions as claimed in claim 1, wherein the second elastic unit is a helical spring.
